(19) United States
(12) Patent Application Publication
(10) Pub. No.: US 2013/0058732 A1
(43) Pub. Date: Mar. 7, 2013

(54) DEVICE FOR REMOTE-CONTROLLED, SUBMARINE MACHINING UNIT

(71) Applicants: Roger Anda, Kleppe (NO); Bjørnar Helgen, Stavanger (NO); Jan Kåre Bredal, Sola (NO)

(72) Inventors: Roger Anda, Kleppe (NO); Bjørnar Helgen, Stavanger (NO); Jan Kåre Bredal, Sola (NO)

(21) Appl. No.: 13/582,720

(22) PCT Filed: Feb. 25, 2011
(86) PCT No.: PCT/NO11/00067

§ 371 Date: Nov. 16, 2012

(30) Foreign Application Priority Data
Mar. 5, 2010 (NO) 20100318

(51) Int. Cl. E21B 29/12; B23B 45/14; B23B 41/12

(52) U.S. Cl. 408/108; 408/111

(57) ABSTRACT

There is described a device for a remote controlled, submarine machining unit arranged for machining of a surface on an installation element by rotation and axial displacement of a tool head and also displacement of one or more cutter holders relative to the tool head, the machining unit being provided with means for releasable mounting of the machining unit at or on the installation element, wherein the tool head is fastened in a rotor shaft axially displaceably supported in a frame and axially rigidly supported in a primary adjustment works enclosing an end portion of the rotor shaft; and a secondary adjustment works is connected to the rotor shaft and comprises means arranged for transfer of a rotary movement of an adjustment handle projecting from the rotor shaft end portion, to a displacement of the cutter holders.

There is described a device for a remote controlled, submarine machining unit arranged for machining of a surface on an installation element by rotation and axial displacement of a tool head and also displacement of one or more cutter holders relative to the tool head, as the machining unit is provided with means for releasable mounting of the machining unit at or on the installation element, more particularly in that the tool head is fastened to a rotor shaft being axially displaceably supported in a frame and axially rigidly supported in a primary adjustment works enclosing an end portion of the rotor shaft; and that there to the rotor shaft is connected a secondary adjustment works comprising means arranged for transfer of a rotary motion of an adjusting handle projecting out from the end portion of the rotor shaft, for a displacement of the cutter holders.

During maintenance of submarine installations such as a well-head on an oil or gas well, there is in certain situations a need for machining of units while they are positioned in their ordinary positions. As an example it occurs that a tubular body, typically a protection pipe being put into a blow out preventer (BOP) to prevent that tools being led down into the well are damaging the BOP internally, gets stuck in the internal bore of the well head in that a portion of the body due to faulty carried out operation is deformed and forced out into a groove or other recesses in an internal wall surface in the internal passage in the wellhead. At worst the problem may not be solved without large parts of the wellhead being dismantled and lifted to the surface for repair, and such operations are in themselves costly. In addition costs related to a production shutdown are incurred.

It is more common that packer seatings or other surfaces are worn or damaged during normal use. The problem to be addressed is somewhat the same as described above, as the repair may not be carried out in situ and calls for large installations needing to be lifted up to the surface for overhaul.

It is known to use fragment removing machining equipment operated by a Remote Operated Vehicle (ROV). ROV-operated milling and turning equipment is known, but in complicated machining operations the machining has at least to be stopped for dismantling and readjustment of the equipment, or alternatively the equipment need to be brought up to the surface for readjustment.

From. NO 172479 B is known a machining device for machining of a worn sealing surface in a location hard to access, for example the material of a valve block, particularly in a subsea installation, as a machining unit comprises a rotatable milling cutter being able to be fed axially, a motor arranged a distance away from the machining unit, and also transmission devices connecting the machining unit and the motor, wherein the machining unit is detachable from the transmission for arbitrary orientation at the location to be machined.

JP 7132372 A describes a sub sea TIG-welding device where only the welding arc producing part of the welding device is arranged under water in a compartment arranged for evacuation of water and produced by a flexible wall comprising a heat resisting, flexible material such as a carbon fiber textile in a lower portion.

GB 1274886 A describes an apparatus for remote operated joining of subsea pipelines, where a joint manipulator is fastened to one end of a pipeline being lowered down to a point near the end of a pipeline already lying on the sea bed. The manipulator arranges the pipe ends, cuts the pipe that the manipulator is fastened to to the correct length and joins the pipelines. The joint is formed by thermal welding, mechanical jointing using a split bushing, or by an explosion mechanical jointing.

GB 2129350 A describes a remote operated cutting apparatus able to be lowered down in a tubular work piece such as a casing in a borehole, to cut a drain slot in the work piece. The apparatus comprises a frame able to be fastened to the work piece by means of hydraulic jacks, and also a sub-frame supporting a hydraulically operated cutting or milling tool able to rotate in a horizontal plane and be displaced in a vertical plane by a motor and a screw.

The object of the invention is to remedy or reduce at least one of the disadvantages of the prior art, or at least procure a useful alternative to the prior art.

The object is achieved by the features disclosed in the below description and in the subsequent claims.

There is provided a machining unit provided with mounting means arranged to be releasably able to fasten the machining unit relative to an element on which one or more machining operations is to be carried out. The machining unit is provided with a rotatable tool head. The tool head is arranged to be able to be displaced during rotation in the direction of the rotational axis, and the tool head is provided with one or more cutter holders arranged to be able to be displaced relative to the tool head while the machining unit is fixed in its working position by the cutter holders being connected to an adjustment mechanism arranged externally on the machining unit. Thus a machining unit is provided which may carry out complicated machining operations with only one setting relative to the element to be machined.

A tubular rotor shaft which in an end portion is rotationwise rigidly fixed to the tool head, is rotationwise rigidly and axially displaceably connected to a rotation drive, where a first rotor drive wheel is supported in a frame, and a rotor drive motor is in operational engagement with the rotor drive wheel. The connection between the rotor shaft and a rotor drive wheel hub is typically formed having several axial grooves (spline coupling).

A second end portion of the rotor shaft is supported in a primary adjustment works comprising one or more linear actuators arranged to be able to displace the rotor shaft in an axial direction.

In one embodiment of the primary adjustment works the primary adjustment works is appropriately formed by an adjustment sleeve being concentric with the rotor shaft, is provided with external threads in engagement with a sleeve nut projecting up from the frame and is rotationwise rigidly connected with the frame. The adjustment sleeve is internally and in a rotationwise rigidly and axially displaceable manner connected to a rotation sleeve being concentric with the rotor shaft and projecting up from the frame in a direction opposite to the tool head. The connection between the adjustment sleeve and the rotation sleeve is typically formed with several axial grooves (spline coupling). The rotation sleeve is rotationwise rigidly fixed in a first primary adjustment drive wheel supported in the frame concentric with the rotor shaft and in rotationwise engagement with a primary adjustment motor. By activation of the primary adjustment motor the first primary adjustment drive wheel and the rotation sleeve are rotated. The adjustment sleeve is thereby also rotated, and due to the threaded connection with the sleeve nut fixed in the frame, the adjustment sleeve and end support of the rotor shaft are screwed. Thus an axial displacement of the tool head is provided.

A secondary adjustment works is rotationwise rigidly connected to the rotor shaft and forms a connection between the tool head cutter feeding actuator and the opposing rotor shaft end. Internally in the rotor shaft is arranged a secondary adjustment shaft between the tool head inside and the second end portion of the rotor shaft, where said adjusting mechanism is arranged with a gear housing fastened to the rotor shaft and a gear arrangement connected to the secondary adjustment shaft. The secondary adjustment shaft is in the tool head connected to the cutter holders with actuator means arranged to transfer a rotating motion of the adjustment shaft for displacement of the cutter heads in the tool head.

More particularly the invention relates to a device for a remote controlled, submarine machining unit arranged for machining of a surface on an installation element by rotation and axial displacement of a tool head and also displacement of one or more cutter holders relative to the tool head, as the machining unit is provided with means for releasable mounting of the machining unit at or on the installation element, characterized in that

the tool head is fastened in a rotor shaft axially displaceably supported in a frame and axially rigidly supported in a primary adjustment works enclosing an end portion of the rotor shaft;

the primary adjustment works comprises one or more linear actuators provided with first transmission means arranged to be able to effect an axial displacement of a rotor bearing relative to the frame; and

to the rotor shaft is connected a secondary adjustment works comprising second transmission means arranged for transfer of a rotary movement of a positioning handle projecting out from the rotor shaft end portion, to a displacement of the cutter holders.

The primary adjustment works may comprise an adjustment sleeve arranged for with a threaded portion to be able to be in a rotatable engagement with a portion of the frame.

The adjustment sleeve may be provided with means arranged to be able to be in a rotationwise rigid engagement with a rotary sleeve being rotationwise rigidly connected with a primary adjustment motor.

The rotation sleeve may be rotatably supported in the frame and externally provided with a series of key ways arranged to be in axially slidable engagement with the adjustment sleeve.

The secondary adjustment works may comprise a secondary adjustment shaft arranged centrically in the rotor shaft and extending between an adjustment works gear arranged on the rotor shaft, and the tool head, the secondary adjustment shaft being connected to one or more cutting feed actuators arranged to be able to effect a displacement of the cutter holders relative to the tool head.

The adjustment handle may be arranged on the adjustment works gear.

The adjustment works gear may be lockable.

The adjustment handle may be arranged to be able to be in engagement with a manipulator arranged on a remote controlled subsea vehicle.

The frame may be provided with a seat arranged to abut a corresponding contact surface on the installation element. Said mounting means may be formed by a series of arms arranged pivotal on the frame and mutually spaced at the seat, as each arm is provided with a gripping portion arranged on a first end portion of the arm, and a linear actuator connects a second end portion of the arm with a remote portion of the frame.

Said cutter holder(s) may be displaceable relative to the tool head at least in a radial direction.

Said surface on the installation element may be an internal surface, and the internal surface may be a cylinder surface, a cone surface or a doubly curved surface.

In the following is described an example of a preferred embodiment illustrated in the accompanying drawings, wherein:

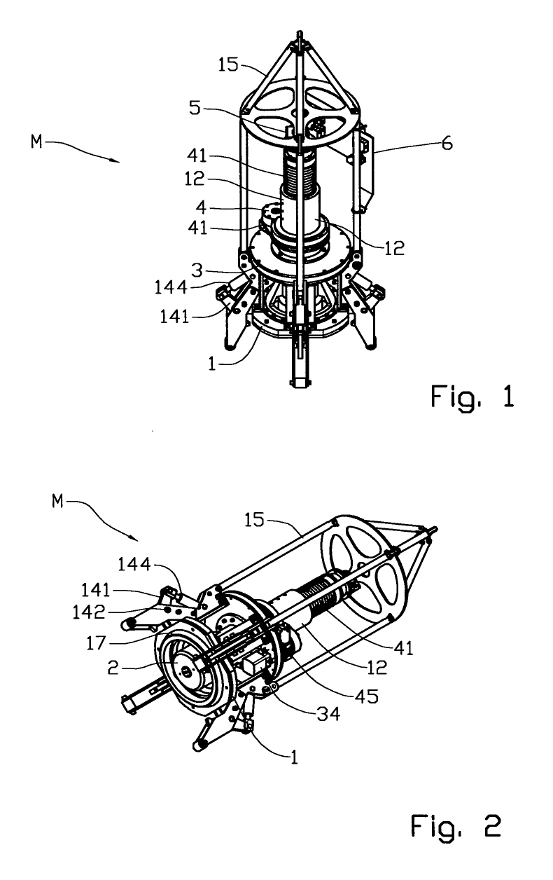

FIG. 1 shows in a first perspective a machining unit according to the invention;

FIG. 2 shows in a second perspective a machining unit according to the invention;

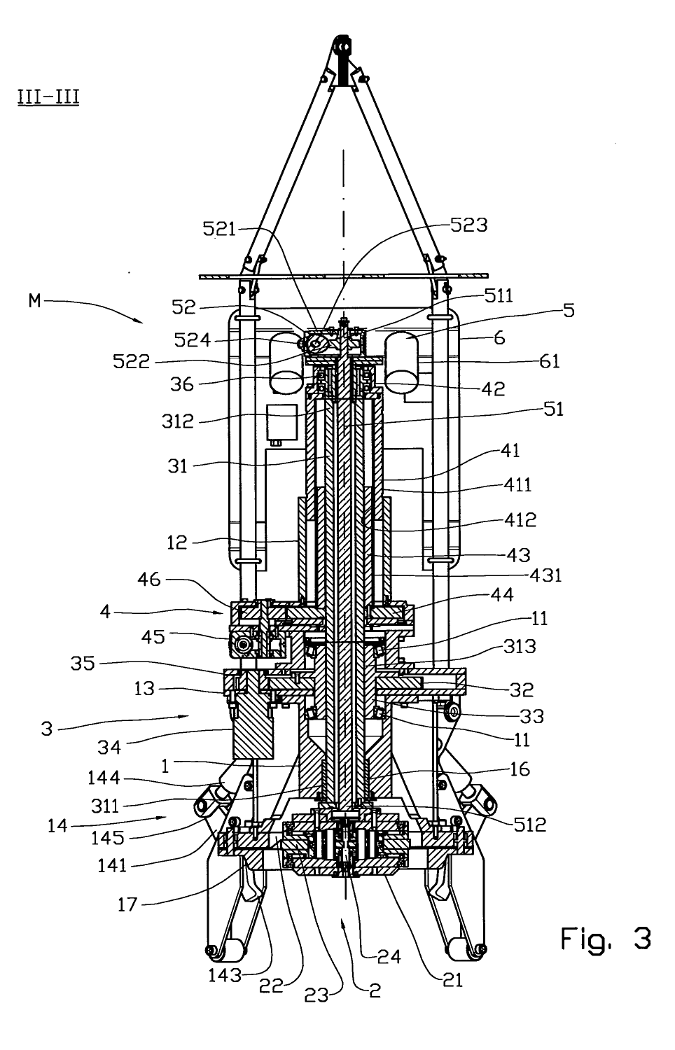

FIG. 3 shows in a larger scale a longitudinal section III-III according to FIG. 5 through the machining unit with a tool head in a first position;

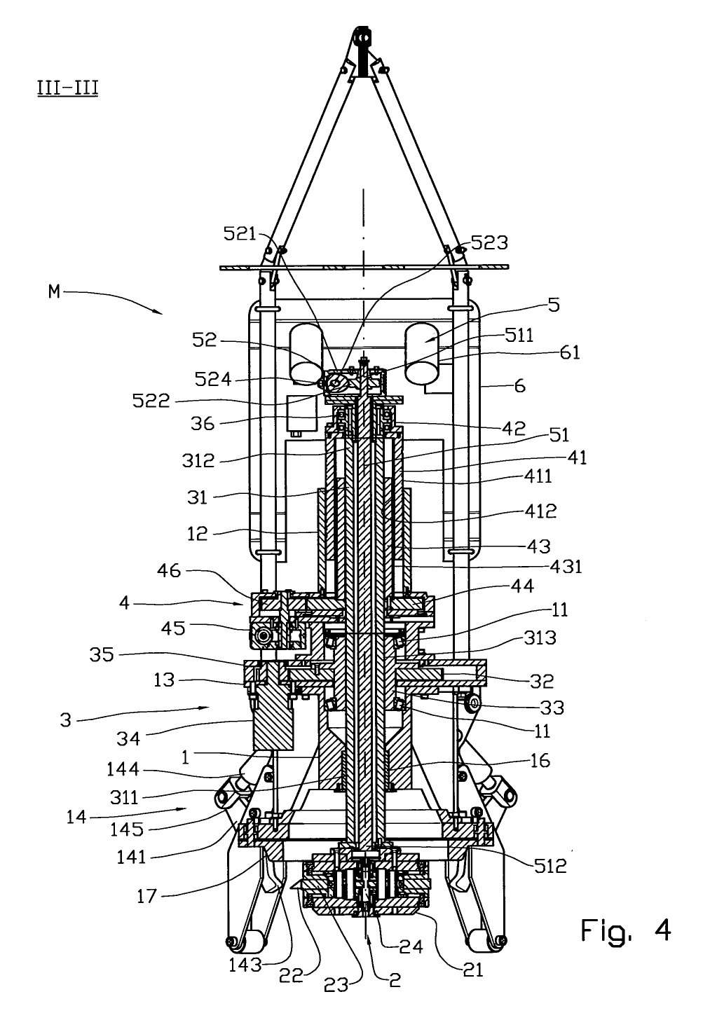

FIG. 4 shows a longitudinal section III-III according to FIG. 5 through the machining unit with a tool head in a second position;

FIG. 5 shows in a smaller scale a plan view of the machining unit;

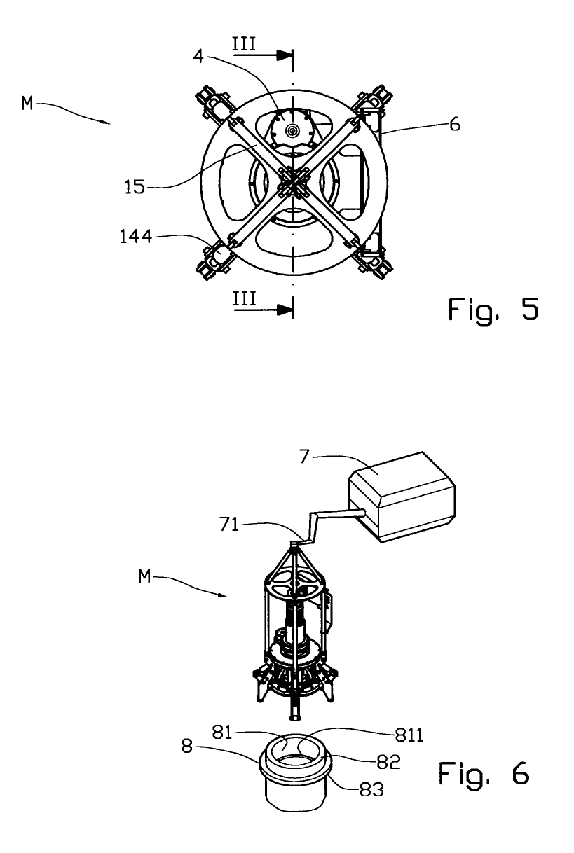

FIG. 6 shows in a smaller scale a schematic perspective view of a machining unit during relocation by means of an ROV near an installation element;

FIG. 7 shows schematically a first alternative embodiment of the tool head where a tool is displaceable along an aslant feed track; and

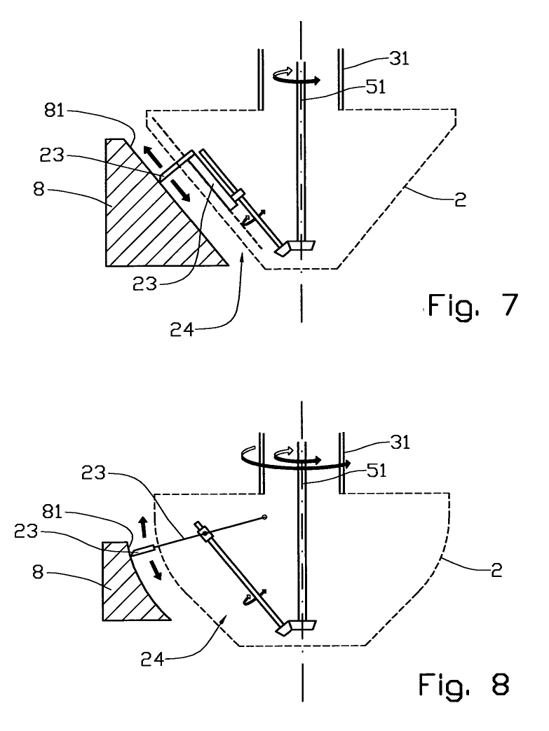

FIG. 8 shows schematically a second alternative embodiment of the tool head where a tool is displaceable along a circular track in a plane coincident with the tool head rotation axis.

A machining unit M according to the invention is provided with a frame 1 and a rotatable tool head 2 connected to a rotation drive 3 supported in the frame 1. A primary adjustment works 4 forms a further support for the rotation drive 3 in the frame 1. A secondary adjustment works 5 is connected to a rotor shaft 31 and the tool head 2. The machining unit M is further provided with an operating panel 6. The machining unit M is arranged to be able to be relocated, installed and operated by means of an ROV 7 and its manipulator 71, only shown schematically here (see FIG. 6). An installation element 8 on a submarine installation, such as a wellhead, is shown schematically.

The frame 1 is provided with a frame bearing 11 arranged for rotatable support of a rotor drive wheel hub 33 where a first rotor drive wheel 32 is rotationally rigidly fastened. A rotor drive motor 34 such as a hydraulic motor, fastened to a portion of the frame 1, is in engagement with the first rotor drive wheel 32 via a second rotor drive wheel 35 arranged on the rotor drive motor 34 drive shaft. Per se known means for supply of energy to the rotor drive motor 34 are not shown or described further.

The rotor shaft 31 is arranged rotatably rigid and axially displaceable in the rotor drive wheel hub 33 in that a portion of the rotor shaft 31 is provided with a series of grooves 313 in slidable engagement with a corresponding portion of the rotor drive wheel hub 33. The rotor shaft 31 is moreover slidably supported in a slide sleeve 16 arranged in a portion of the frame 1.

The tool head 2 is fastened to a first end portion 311 of the rotor shaft 31. In a second end portion 312 is arranged a rotor bearing 36 fastened in a bearing housing 42 on the primary adjustment works 4.

The primary adjustment works 4 comprises a primary adjustment motor 45 such as a hydraulic motor fastened in a portion of the frame 1. Per se known means for energy supply to the primary adjustment motor 45 are not shown or discussed further. A first primary adjustment gear 44 is arranged supported in the frame 1 concentric with the rotor shaft 31 and in engagement with a second primary adjustment gear 46 arranged on the primary adjustment motor 45 drive shaft. A rotation sleeve 43 is fastened to the first primary adjustment gear 44 and projects up toward the second end portion 312 of the rotor shaft 31, arranged concentrically with the rotor shaft 31. A portion of an adjustment sleeve 41 encloses a portion of the rotation sleeve 43, as a series of grooves 431 arranged axially on the periphery of the rotation sleeve 43 forms a slidable, rotationally rigid connection with corresponding eminences 412 on the adjustment sleeve 41. On an end portion of the adjustment sleeve 41 is arranged the bearing housing 42 for the rotor bearing 36.

On the external wall surface of the adjustment sleeve 41 is arranged a threaded portion 411 in engagement with a corresponding, internal threaded portion in a sleeve nut 12 being rotatably rigidly fastened in and projecting up from the frame 1.

In a centric through opening in the rotor shaft 31 is arranged a secondary adjustment shaft 51, which together with an adjustment works gear 52, arranged on an end portion projecting up from the rotor shaft 31, and cutting feed actuators 24 arranged in the tool head 2 forms the secondary adjustment works. The adjustment works gear 52 comprises a gear housing 521 fastened to the rotor shaft 31, a worm shaft 523 and a worm gear 522 fastened to a first end portion 511 of the secondary adjustment shaft 51 and in engagement with the worm shaft 523. An adjustment handle 524 is arranged on an end portion of the worm shaft 523 projecting out from the gear housing 521.

In the tool head 2 comprising a housing 21, is in a first embodiment example arranged several radially displaceable cutter holders 23 each forming an attachment for a cutting tool 22. The cutting feed actuators 24 is connected to the cutter holders 23 and a second end portion 512 of the secondary adjustment shaft 51, and a rotation of the secondary adjustment shaft 51 relative to the tool head 2 is transformed to a radial displacement of the cutter holders 23. For a person skilled in the art it will be apparent that a long list of technical solutions may be utilized for the purpose, for example bevel gear drives with feeding of the cutter holders 23 by threaded rods.

The operating panel 6 is provided with appropriate operating controls 61, such as for starting and stopping the motors 34, 45.

The machining unit M is provided with means (not shown) for indication of the rotational speed of the tool head 2 and the position of the cutters 22 relative to a reference system, to thereby be able to give remote reading of relevant machining parameters.

More mounting means 14 are fastened to the frame 1, as more arms 141 are pivotal connected to the frame 1 by means of a linear actuator 144. An opposing end portion of the arm 141 forms a gripping portion 143 arranged for releasable engagement with a portion 83 of the installation element 8.

A spreader bar 15 is fastened to the frame 1 and is provided with means for releasable connection to the ROV 7 or to a lifting means (not shown).

The installation element 8, shown schematically (see FIG. 6), comprises an internal surface 81 having one or more portions 811 to be machined. The installation element 8 is provided with a seating surface 82 arranged to be able to support a contact face 17 formed in the frame 1. The installation element 8 is further provided with a mounting surface 83, such as a flange, arranged for receiving mounting means 14 arranged on the frame 1.

When an installation element 8 is to be machined, the machining unit M is positioned relative to the installation element 8 by means of the ROV 7, possible with assistance from further ROVs 7 or other remedies. The contact face 17 on the frame 1 is directed toward the seating surface 82 of the installation element 8 for centering of the machining unit M, and it is mounted by the mounting means 14 being activated for contact against the mounting surface 83 of the installation element 8.

The tool head 2 is placed in the desired axial position by means of the primary adjusting motor 45. The cutters 22 are then displaced out to a desired radial position by the ROV 7 operating the secondary adjustment works' 5 adjustment handle 524. The tool head 2 is then set in rotation by means of the rotor drive motor 34, and the tool head 2 is displaced successively in the axial direction by means of the primary adjustment motor 45 while the tool head 2 rotates. The depth of cut for the cutters 22 is reset after the rotation of the tool head 2 has stopped. Shavings formed may be collected by suitable, not shown means preinstalled under the machining unit M, further inside the installation element 8. After completion of the machining operation, the cutter holders 23 are withdrawn inside the housing 21, and the machining unit M is removed from the installation element 8 by means of the ROV 7, possible with assistance from further ROVs 7 or other remedies.

In a second embodiment example, shown schematically in FIG. 7, the cutter holder 23 is arranged slanting relative to a radial plane through the tool head 2. The cutter holder 23 is displaceable parallel with the internal surface 81 to be machined, as this surface 81 is conical.

In a third embodiment example, shown schematically in FIG. 8, the cutter holder 23 is arranged rotatable about an axis parallel to a radial plane through the tool head 2. The cutter holder 23 is displaceable in a sector in a plane parallel to the rotor shaft 31 central axis and having a radius corresponding to the radius of curvature of the internal surface 81 to be machined, as this surface has a double curvature.

1. A device for a remote controlled, submarine machining unit arranged for machining of a surface on an installation element by rotation and axial displacement of a tool head and also displacement of one or more cutter holders relative to the tool head, the machining unit being provided with means for releasable mounting of the machining unit at or on the installation element, wherein
the tool head is fastened in a rotor shaft axially displaceably supported in a frame and axially rigidly supported in a primary adjustment works enclosing an end portion of the rotor shaft;
the primary adjustment works comprises one or more linear actuators provided with first transmission means arranged to be able to effect an axial displacement of a rotor bearing relative to the frame; and
a secondary adjustment works is connected to the rotor shaft and comprises second transmission means arranged for transfer of a rotary movement of an adjustment handle projecting from the rotor shaft end portion to a displacement of the cutter holders

2. The device according to claim 1, wherein the primary adjustment works comprises an adjustment sleeve arranged to, by means of a threaded portion, be able to be in rotatable engagement with a portion of the frame.

3. The device according to claim 1, wherein the adjustment sleeve is provided with means arranged to be able to be in rotationally rigid engagement with a rotation sleeve being rotationally rigidly connected to a primary adjustment motor.

4. The device according to claim 3, wherein the rotation sleeve is rotationally supported in the frame and is externally provided with a series of key ways arranged to be in axially slidable engagement with the adjustment sleeve.

5. The device according to claim 1, wherein the secondary adjustment works comprises a secondary adjustment shaft arranged centrically in the rotor shaft and extending between an adjustment works gear arranged on the rotor shaft, and the tool head, the secondary adjustment shaft being connected to one or more cutter feeding actuators arranged to be able to effect a displacement of the cutter holders relative to the tool head.

6. The device according to claim 5, wherein the adjustment handle is arranged on the adjustment works gear.

7. The device according to claim 5, wherein the adjustment works gear is lockable.

8. The device according to claim 5, wherein the adjustment handle is arranged to be able to be in engagement with a manipulator arranged on a remote operated subsea vehicle.

9. The device according to claim 1, wherein the frame is provided with a seat arranged to be able to abut a corresponding contact surface on the installation element.

10. The device according to claim 1, wherein said mounting means are formed by a series of arms arranged pivotal on the frame in a spaced relationship at the seat, each arm being provided with a gripping portion arranged on a first end portion of the arm, and a linear actuator connecting a second end portion of the arm with a remote portion of the frame.

11. The device according to claim 1, wherein said cutter holder(s) are displaceable relative to the tool head at least in a radial direction.

12. The device according to claim 1, wherein said surface on the installation element is an internal surface.

13. The device according to claim 12, wherein said internal surface is a cylinder surface, a cone surface or a double curvature surface.
